(19) United States
(12) Patent Application Publication
(10) Pub. No.: US 2022/0388759 A1
(43) Pub. Date: Dec. 8, 2022

(54) PAPER-BASED THERMAL INSULATION POUCHES

(71) Applicant: Cryovac, LLC, Charlotte, NC (US)

(72) Inventors: Ronak K. Patel, Charlotte, NC (US); Ira Gelfond, Torrington, CT (US)

(21) Appl. No.: 17/771,046

(22) PCT Filed: Oct. 21, 2020
(86) PCT No.: PCT/US2020/056594

§ 371 Date: Apr. 22, 2022

Related U.S. Application Data
(60) Provisional application No. 62/924,727, filed on Oct. 23, 2019.

(51) Int. Cl. B65D 81/38; B31B 50/00; B31B 50/26; B31B 70/26

(52) U.S. Cl. CPC B65D 81/3897; B65D 81/3858; B31B 50/002; B31B 50/262; B31B 70/261; B31B 70/262; B31B 2100/0024

(57) ABSTRACT

Pouch including an insulation pad (100) including two juxtaposed cellulose-based sheets (110, 112) and a cellulose-based insulation material (120). The two juxtaposed cellulose-based sheets are laminated together with the cellulose-based insulation material located therebetween. The pouch further includes transverse fold lines (134) in the insulation pad. The pouch further includes two W-shaped folds (140) in the insulation pad. The two W-shaped folds are formed by folding the insulation pad along the transverse fold lines. Portions of a first longitudinal edge (116) of the insulation pad are coupled to each other between the two W-shaped folds in the insulation pad.

### BACKGROUND

The present disclosure is in the technical field of paper-based thermal insulation. More particularly, the present disclosure is directed to paper-based thermal insulation pouches that can be formed from an insulation pad.

Consumers frequently purchase goods from e-commerce retailers (e.g., mail-order retailers, internet retailers, etc.). E-commerce retailers package and ship the goods to the purchasing consumer via a postal service or other carrier. Millions of such packages are shipped each day. These items are normally packaged in small containers, such as boxes or envelopes. To protect the items during shipment, they are typically packaged with some form of protective dunnage that may be wrapped around the item or stuffed into the container to prevent movement of the item and to protect it from shock.

Increasingly, consumers are purchasing temperature-sensitive goods from mail-order or internet retailers. Temperature-sensitive goods include food items, such as groceries, ready meal kits, and the like. Temperature-sensitive goods also include pharmaceuticals, such as medications. Temperature-sensitive goods can include any number of other goods that benefit from being in an environment that is either below or above a particular temperature.

When shipping temperature-sensitive goods, thermal-insulating packaging materials have been used to control the temperature inside of shipping containers (e.g., the temperature inside of a cardboard shipping box. Traditional thermal-insulating packaging materials, such as polystyrene foam, have superior thermal insulation properties and act as a moisture barrier. However, traditional thermal-insulating packaging materials are not easily reused and cannot be easily recycled.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In a first embodiment, a method includes forming an insulation pad into a tube shape. The insulation pad includes two juxtaposed cellulose-based sheets and a cellulose-based insulation material. The two juxtaposed cellulose-based sheets are laminated together with the cellulose-based insulation material located therebetween. The insulation pad includes a plurality of transverse fold lines. The method further includes folding the insulation pad along the plurality of transverse fold lines to form two W-shaped folds in the insulation pad and coupling portions of a first longitudinal edge of the insulation pad to each other between the two W-shaped folds in the insulation pad to close one end of the tube shape and form a pouch from the insulation pad.

In a second embodiment, method of the first embodiment further includes forming one of the plurality of transverse fold lines by directing a stream of compressed gas along a linear path in the cellulose-based insulation material before the two juxtaposed cellulose-based sheets are laminated together.

In a third embodiment, the insulation pad of any of the preceding embodiments further includes a first longitudinal fold line.

In a fourth embodiment, the method of the third embodiment further includes folding the pouch along the first longitudinal fold line so that the pouch opens from a lay-flat configuration to an open configuration.

In a fifth embodiment, when the pouch of the fourth embodiment is in the open configuration, portions of the insulation pad are in an overlapping arrangement on an inner side of a bottom of the pouch.

In a sixth embodiment, the portions of the insulation pad of the fifth embodiment that are in the overlapping arrangement include an insulation region of the insulation pad.

In a seventh embodiment, the insulation region of the sixth embodiment has an R-value per inch in a range between about 3.70 and about 3.98 (an RSI-value per millimeter in a range between about 0.652 and about 0.701).

In an eighth embodiment, the insulation region of any of the sixth to seventh embodiments has an average thickness equal to or greater than 0.2 inches (5.1 mm).

In a ninth embodiment, the method of any of the fifth to eighth embodiments further includes placing a product in the pouch and on the portions of the insulation pad that are in the overlapping arrangement on the inner side of the bottom of the pouch.

In a tenth embodiment, the method of the ninth embodiment further includes closing the pouch from the open configuration to a closed configuration after placing the product in the pouch.

In an eleventh embodiment, the insulation pad of the tenth embodiment further includes lines of weakness between a second longitudinal fold line in the insulation pad and a second longitudinal edge. Closing the pouch further includes breaking the lines of weakness to form flaps in between the second longitudinal fold line in the insulation pad and the second longitudinal edge of the insulation pad and folding the flaps about the second longitudinal fold line.

In a twelfth embodiment, the insulation pad of any of the tenth to eleventh embodiments includes slits between a second longitudinal fold line in the insulation pad and a second longitudinal edge, the insulation pad further includes flaps bordered by the second longitudinal fold line in the insulation pad, the second longitudinal edge of the insulation pad, and at least two of the slits, and closing the pouch comprises folding the flaps about the second longitudinal fold line.

In a thirteenth embodiment, the method of any of the fourth to twelfth embodiments further includes inserting the pouch into a shipping container. When the pouch is in the open configuration and inside of the shipping container, the pouch serves as a thermally-insulating liner along inner sides of the shipping container.

In a fourteenth embodiment, folding the pouch of any of the fourth to thirteenth embodiments along the first longitudinal fold line includes exerting a compressive force between the first longitudinal edge and a second longitudinal edge of the insulation pad while the pouch is in the lay-flat configuration. The compressive force causes the insulation pad to fold at the first longitudinal fold line to open the pouch to the open configuration.

In a fifteenth embodiment, forming the insulation pad into the tube shape in any of the preceding embodiments includes coupling a first transverse side of the insulation pad to a second transverse side of the insulation pad.

In a sixteenth embodiment, the insulation pad of any of the preceding embodiments comprises a plurality of insulation pad pieces that are coupled to each other.

In a seventeenth embodiment, a pouch includes an insulation pad comprising two juxtaposed cellulose-based sheets and a cellulose-based insulation material. The two juxtaposed cellulose-based sheets are laminated together with the cellulose-based insulation material located therebetween. The pouch further includes a plurality of transverse fold lines in the insulation pad and two W-shaped folds in the insulation pad. The two W-shaped folds are formed by folding the insulation pad along the plurality of transverse fold lines. Portions of a first longitudinal edge of the insulation pad are coupled to each other between the two W-shaped folds in the insulation pad.

In an eighteenth embodiment, the pouch of the seventeenth embodiment further includes a first longitudinal fold line in the insulation pad.

In a nineteenth embodiment, the pouch of the eighteenth embodiment is configured to open from a lay-flat configuration to an open configuration when the insulation pad is folded about the first longitudinal fold line.

In a twentieth embodiment, when the pouch of the nineteenth embodiment is in the open configuration, portions of the insulation pad are in an overlapping arrangement on an inner side of a bottom of the pouch.

In a twenty first embodiment, the he portions of the insulation pad of the twentieth embodiment that are in the overlapping arrangement include an insulation region of the insulation pad.

In a twenty second embodiment, the insulation region of the twenty first embodiment has an R-value per inch in a range between about 3.70 and about 3.98 (an RSI-value per millimeter in a range between about 0.652 and about 0.701).

In a twenty third embodiment, the insulation region of any of the twenty first to twenty second embodiments has an average thickness equal to or greater than 0.2 inches (5.1 mm).

In a twenty fourth embodiment, the insulation region of the twenty third embodiment in the overlapping arrangement is folded such that at least two thicknesses of the insulating region are above the inner side of the bottom of the pouch.

In a twenty fifth embodiment, the insulation pad of any of the seventeenth to twenty fourth embodiments includes lines of weakness between a second longitudinal fold line in the insulation pad and a second longitudinal edge of the insulation pad. When the line of weakness are broken, the portions of the insulation pad between the second longitudinal fold line and the second longitudinal edge are flaps that can be folded about the second longitudinal fold line to close the pouch.

In a twenty sixth embodiment, a first transverse side of the insulation pad of any of the seventeenth to twenty fifth embodiments is coupled to a second transverse side of the insulation pad.

In a twenty seventh embodiment, the insulation pad of any of the seventeenth to twenty sixth embodiments comprises a plurality of insulation pad pieces that are coupled to each other.

In a twenty eighth embodiment, a package includes the pouch of any of the seventeenth to twenty sixth embodiments, a product in the pouch, and a cold pack in the pouch.

In a twenty ninth embodiment, the product of the twenty eighth embodiment is placed on the portions of the insulation pad that are in the overlapping arrangement on the inner side of the bottom of the pouch.

In a thirtieth embodiment, the product of the twenty ninth contacts the portions of the insulation pad that are in the overlapping arrangement and the product is not in contact with the bottom of the pouch.

In a thirty first embodiment, the cold pack of the thirtieth embodiment is placed in the pouch such that condensation from the cold pack is capable of flowing to and pooling on the bottom of the pouch so that the product is not in contact with pooled condensation on the bottom of the pouch.

In a thirty second embodiment, the package of any of the twenty eighth to thirty first embodiments further includes a shipping container and the pouch is positioned as a liner along inner sides of the shipping container.

### BRIEF DESCRIPTION OF THE DRAWING

The foregoing aspects and many of the attendant advantages of the disclosed subject matter will become more readily appreciated as the same become better understood by reference to the following detailed description, when taken in conjunction with the accompanying drawings, wherein:

FIGS. 1A and 1B depict side and front views, respectively, of a first instance of formation of an insulation pad that can be used to make a thermal insulation pouch, in accordance with the embodiments disclosed herein;

FIGS. 2A and 2B depict side and front views, respectively, of a second instance of formation of the insulation pad show in FIGS. 1A and 1B, in accordance with the embodiments disclosed herein;

FIGS. 3A and 3B depict side and front views, respectively, of a third instance of formation of the insulation pad show in FIGS. 1A to 2B, in accordance with the embodiments disclosed herein;

FIGS. 4A to 4G depict instances of an embodiment of a method of forming the insulation pad shown in FIGS. 3A and 3B into an insulation pouch and using the insulation pouch as thermal insulation for a shipping container, in accordance with the embodiments disclosed herein;

FIGS. 5A and 5B depict top and cross-sectional views, respectively, of the pouch shown in FIG. 4E in an open configuration, in accordance with the embodiments disclosed herein;

FIGS. 6A and 6B depict top and cross-sectional views, respectively, of a package that includes a shipping container with its flaps closed, the insulation pouch shown in FIG. 4G in the closed configuration, and a product inside the insulation pouch, in accordance with the embodiments disclosed herein;

FIG. 7 depicts an embodiment of an insulation pad that is a variation of the insulation pad show in FIGS. 3A and 3B and includes lines of weakness to allow a user to easily break the insulation pad to form flaps, in accordance with the embodiments disclosed herein;

FIG. 8 depicts a front view of an embodiment of an insulation pad that can be formed into an insulation pouch, in accordance with the embodiments disclosed herein;

FIGS. 9A to 9D depict an embodiment of the transition, from a lay-flat configuration to an open configuration, of an insulation pouch from the insulation pad shown in FIG. 8, in accordance with the embodiments disclosed herein;

FIG. 10 depicts a variation of the pouch shown in FIG. 4D where inner sides of the longitudinal edge of the insulation pouch are coupled to each other, in accordance with the embodiments disclosed herein;

FIGS. 11A and 11B depict perspective and top views, respectively, of an embodiment of an insulation pouch in an open configuration, where the insulation pouch is a variation of the insulating pouch shown in FIGS. 9B and 9C that has different dimensions, in accordance with the embodiments disclosed herein;

FIGS. 12A and 12B depict side and front views, respectively, of insulation pad pieces that can be combined to form an insulation pad, in accordance with the embodiments disclosed herein; and

FIGS. 13A and 13B depict side views of instances of a method of coupling the insulation pad pieces shown in FIGS. 12A and 12B to form an insulation pad with W-shaped folds, in accordance with the embodiments disclosed herein.

### DETAILED DESCRIPTION

Paper-based thermal insulation pads have been used as thermal-insulating packaging materials. Paper-based thermal insulation pads are typically rectangular in shape. For example, TempGuard™ paper-based thermal insulation pads, produced by Sealed Air Corporation, are rectangular-shaped, paper-based thermal insulation pads that can be used as liners in shipping boxes. These paper-based thermal insulation pads are typically folded into a “C” shape and placed in a shipping container along three sides of the container. Two or three of these C-shaped paper-based thermal insulation pads can be used in a single shipping container so that all sides of the container are lined by at least one of the paper-based thermal insulation pads. Typically, the paper-based thermal insulation pads are easily recyclable, such as being curbside recyclable for many consumers.

While paper-based thermal insulation pads have been used in the past, there is room for improvement. For example, using two or three folded paper-based thermal insulation pads may cover all of the inner sides of a shipping container; however, the use of multiple paper-based thermal insulation pads leaves gaps between the pads where air and moisture can pass. The ability of air to pass through gaps in the pads reduced the thermal insulation of the entire package. The ability of moisture to pass through gaps in the pads allows water on the inside of the package (e.g., due to condensation from a cold pack in the package) to leak through the thermal-insulating packaging materials can contact the shipping container. In some cases, the moisture that can leak through to the shipping container can do significant damage to the shipping container during shipment. Not only can this leaked moisture damage the shipping container, but it is also aesthetically unpleasing and can cause consumers to lose confidence in the propriety of the shipping materials to maintain an appropriate temperature for the contents of the package.

Efforts have been made to make a single, paper-based thermal insulation package. For example, Lenart, et al., WO 2019/113453 A1, shows an insulated bag. This type of insulated bag may address some of the issues of removing gaps that allow air and moister to pass. However, these types of insulated bags also trap moisture. Moisture can especially be a problem inside of thermal-insulating packaging materials when a cold pack is used inside of the packaging materials because condensation tends to form around the cold pack. The insulated bag can allow moisture to pool at the bottom of the bag and any objects sitting on the bottom of the insulated bag to remain in contact with the pooled moisture. It would be advantageous for a paper-based thermal insulation package that eliminates gaps between the distinct pads while also reducing the likelihood that an object on the bottom of the insulated bag sits in pooled moisture.

The present disclosure describes embodiments of paper-based thermal insulation pouches that can be formed from an insulation pad. In some embodiments, a pouch can be used for thermal insulation for an object placed therein. The pouch includes an insulation pad that includes two juxtaposed cellulose-based sheets and a cellulose-based insulation material. The two juxtaposed cellulose-based sheets are laminated together with the cellulose-based insulation material located therebetween. The pouch further includes transverse fold lines in the insulation pad. The pouch further includes two W-shaped folds in the insulation pad. The two W-shaped folds are formed by folding the insulation pad along the transverse fold lines. Portions of a first longitudinal edge of the insulation pad are coupled to each other between the two W-shaped folds in the insulation pad. Other variations are possible in accordance with the other embodiments disclosed herein.

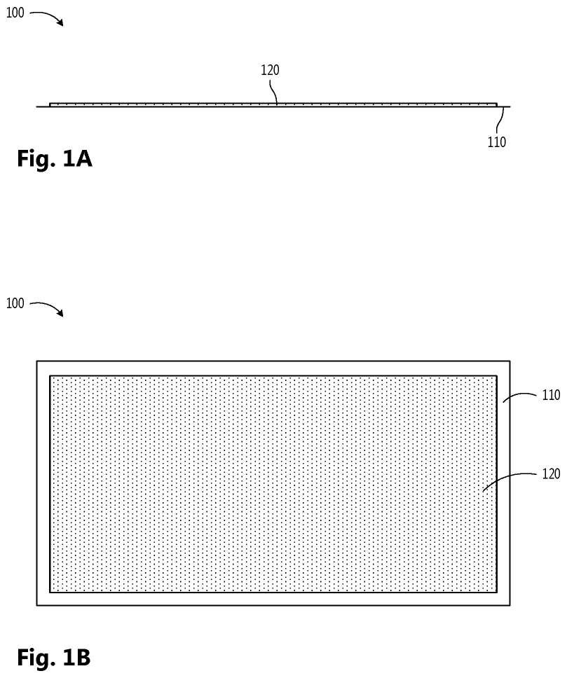

FIGS. 1A to 3B depict instances of an embodiment of forming an insulation pad 100 that can be used to make a thermal insulation pouch. More specifically, FIGS. 1A and 1B depict side and front views, respectively, of a first instance of formation of the insulation pad 100. In the first instance shown in FIGS. 1A and 1B, the insulation pad 100 includes a first sheet 110 and an insulation material 120. In some embodiments, the first sheet 110 is a cellulose-based sheet. For example, the first sheet 110 can be paper, Kraft paper (e.g., 30# Kraft paper, 35# Kraft paper, 40# Kraft paper, 50# Kraft paper, etc.), coated paper, cotton paper, or any other type of paper.

In some embodiments, the insulation material 120 is a cellulose-based insulation material. For example, the insulation material 120 can include natural fibers (cotton, wool, etc.), manufactured cellulose fibers (e.g., rayon, viscose), processed materials (e.g., pulp, paper, etc.), any other cellulose-based material, or any combination thereof. In some embodiments, the first sheet 110 and the insulation material 120 are made from materials that are recyclable without separating the first sheet 110 from the insulation material 120, such as where the first sheet 110 is Kraft paper and the insulation material 120 is shredded paper. In some embodiments, one or both of the first sheet 110 and the insulation material 120 includes post-consumer content, such as when the insulation material 120 is post-consumer shredded paper.

In some embodiments, before the insulation material 120 is placed on the first sheet 110, an adhesive is applied to the entire surface of the first sheet 110 on which the insulation material 120 is placed. In this way, a portion of the insulation material 120 can bond to the first sheet 110. In embodiments where the insulation material includes loose pieces (e.g., loose natural fibers, loose shredded paper, etc.), not all of the loose pieces will bond to the first sheet 110. In some embodiments, the adhesive may be any type of adhesive, such as 22% solids poly(vinyl acetate) glue. In the depicted embodiment, as can be seen in FIG. 1B, the insulation material 120 is placed on the first sheet 110 so that the insulation material 120 does not cover areas of the first sheet 110 near each of the sides of the first sheet 110.

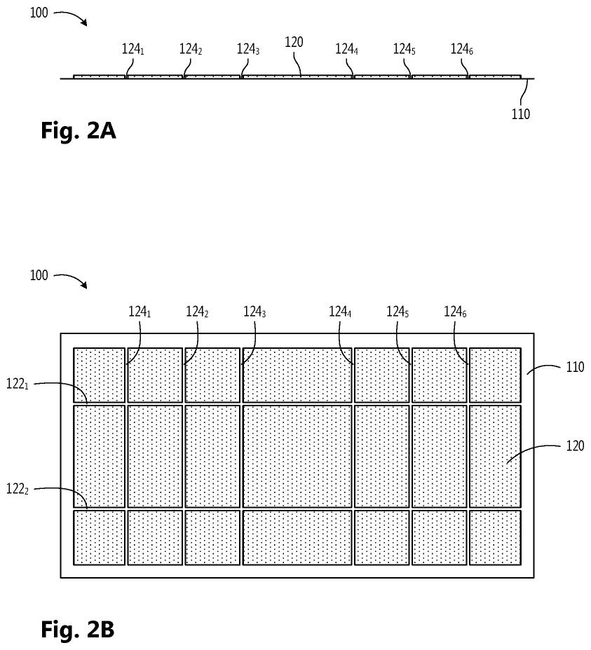

FIGS. 2A and 2B depict side and front views, respectively, of a second instance of formation of the insulation pad 100. In the second instance shown in FIGS. 2A and 2B, longitudinal reduction lines 122₁, 122₂ (collectively, longitudinal reduction lines 122) and transverse reduction lines 124₁, 124₂, 124₃, 124₄, 124₅, 124₆ (collectively, transverse reduction lines 124) have been formed in the insulation material 120. Each of the longitudinal reduction lines 122 and the transverse reduction lines 124 is a line where at least a portion of the insulation material 120 has been reduced. In some embodiments, each of the longitudinal reduction lines 122 and the transverse reduction lines 124 is a line where the insulation material 120 has been entirely removed from at least a portion of the first sheet 110 along the line. In some embodiments, the longitudinal direction is the direction parallel to the longest edge of the first sheet 110 (e.g., left-to-right in the depicted embodiment) and the transverse direction is the direction perpendicular to the longest edge of the first sheet 110 (e.g., top-to-bottom in the depicted embodiment). In some embodiments, each of the longitudinal reduction lines 122 and the transverse reduction lines 124 is formed by directing a stream of compressed gas along a linear path in the insulation material 120 before the first sheet 110 is laminated to another sheet material.

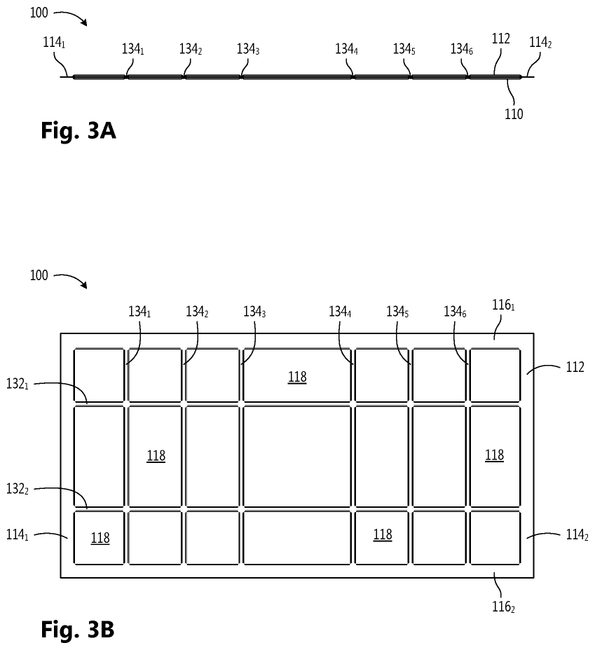

FIGS. 3A and 3B depict side and front views, respectively, of a third instance of formation of the insulation pad 100. In the third instance shown in FIGS. 3A and 3B, the insulation pad 100 further includes a second sheet 112. The first and second sheets 110 and 112 are juxtaposed with respect to each other. In some embodiments, the second sheet 112 is a cellulose-based sheet. For example, the second sheet 112 can be paper, Kraft paper (e.g., 30# Kraft paper, 35# Kraft paper, 40# Kraft paper, 50# Kraft paper, etc.), coated paper, cotton paper, or any other type of paper. In some embodiments, the first and second sheets 110 and 112 are made from the same type of cellulose-based material, such as when the first and second sheets 110 and 112 are both Kraft paper.

In the depicted embodiment, the first and second sheets 110 and 112 are laminated together with the insulation material 120 located therebetween. In some embodiments, before the second sheet 112 is laminated to the first sheet 110, an adhesive is applied to the entire surface of the second sheet 112 that comes into contact with the insulation material 120 and the first sheet 110. In this way, a portion of the insulation material 120 can bond to the second sheet 112. In embodiments where the insulation material includes loose pieces (e.g., loose natural fibers, loose shredded paper, etc.), not all of the loose pieces will bond to the first sheet 110. In some embodiments, the adhesive may be any type of adhesive, such as 22% solids poly(vinyl acetate) glue.

The adhesive on the first sheet 110 and/or the second sheet 112 can cause the first and second sheets 110 and 112 to be bonded to each other. The first and second sheets 110 and 112 are bonded together in the areas where the insulation material 120 is not located between the first and second sheets 110 and 112. In the depicted embodiment, the first and second sheets 110 and 112 along transverse edges 114₁, 114₂ (collectively, transverse edges 114) of the insulation pad 100, along longitudinal edges 116₁, 116₂ (collectively, longitudinal edges 116) of the insulation pad 100, along longitudinal fold lines 132₁, 132₂ (collectively, longitudinal fold lines 132) of the insulation pad 100, and along transverse fold lines 134₁, 134₂, 134₃, 134₄, 134₅, 134₆ (collectively, transverse fold lines 134) of the insulation pad 100. In some embodiments, the laminating of the first and second sheets 110 and 112 along the transverse and longitudinal edges 114 and 116 and along the longitudinal and transverse fold lines 132 and 134 forms insulation regions 118 where the insulation material 120 is located between the first and second sheets 110 and 112.

The longitudinal fold lines 132 and the transverse fold lines 134 are more easily folded than other areas of the insulation pad 100, such as the insulation regions 118. While the longitudinal fold lines 132 and the transverse fold lines 134 may be easier to fold than the insulation regions 118, it will be appreciated that the insulation regions 118 can be folded. Examples of fold the insulation regions 118 are discussed below. In some embodiments, the longitudinal fold lines 132 and the transverse fold lines 134 are more easily folded than the insulation regions 118 because there is less of the insulation material 120 between the first and second sheets 110 and 112 in the longitudinal fold lines 132 and the transverse fold lines 134 than in the insulation regions 118. In some embodiments, none of the insulation material 120 is located between the first and second sheets 110 and 112 in portions of the longitudinal fold lines 132 and the transverse fold lines 134. In some embodiments, insulation material 120 is located between the first and second sheets 110 and 112 in the longitudinal fold lines 132 and the transverse fold lines 134, but the thickness of the insulation material 120 in the longitudinal fold lines 132 and the transverse fold lines 134 is less than the average thickness of the insulation material 120 in the insulation regions 118.

In some embodiments, the insulation pad 100 has thermal properties that allow the insulation pad 100 to be used in particular packaging situations. A thermal resistive value for a given material can be measured in imperial units as an “R-value” (measured in units of ft²·° F.·h/BTU) or in metric units as an “RSI-value” (measured in units of m²·K/W). The higher the thermal resistance value, the slower the rate of heat transfer through the material. Insulation materials are typically rated by their thermal resistive value per unit thickness, such as R-value per inch or RSI-value per millimeter. In some embodiments, the insulation pad 100 has an R-value per inch between about 3.70 and about 3.98 (an RSI-value per millimeter in a range between about 0.652 and about 0.701). In some embodiments, at least one of the insulation regions 118 of the insulation page 100 has an R-value per inch between about 3.70 and about 3.98 (an RSI-value per millimeter in a range between about 0.652 and about 0.701). In some embodiments, the insulation regions 118 have an average thickness equal to or greater than one or more of 0.2 inches (5.1 mm), 0.3 inches (7.6 mm), 0.4 inches (10.2 mm), or 0.5 inches (12.7 mm).

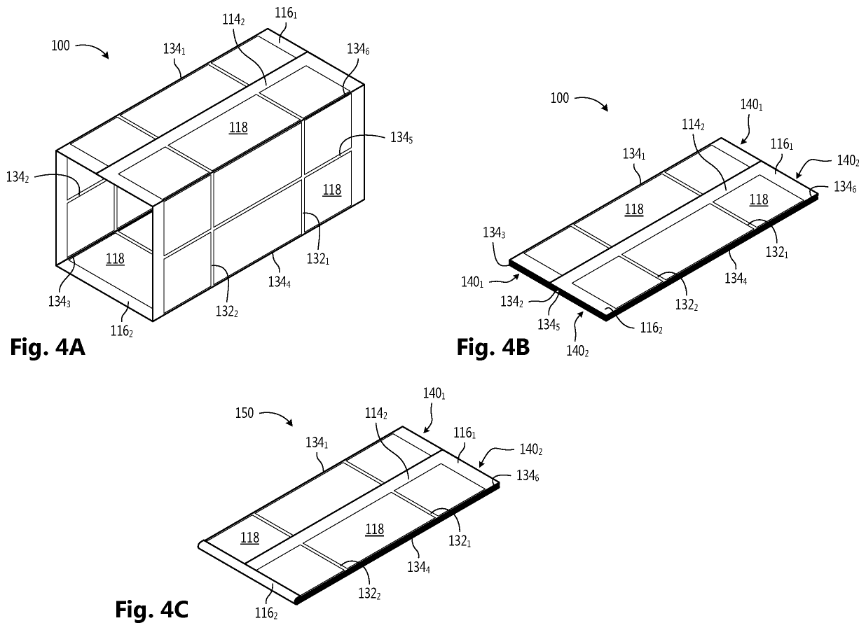

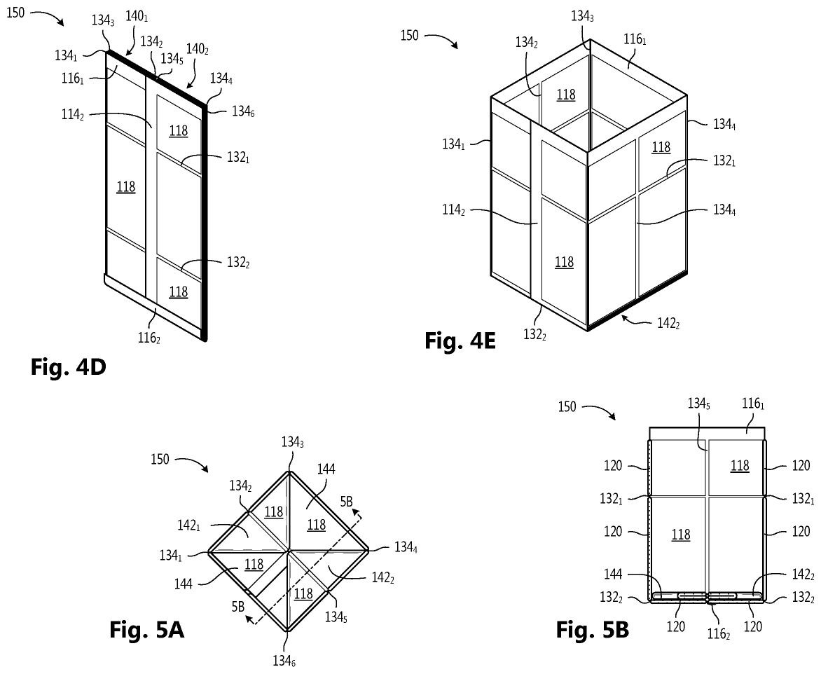

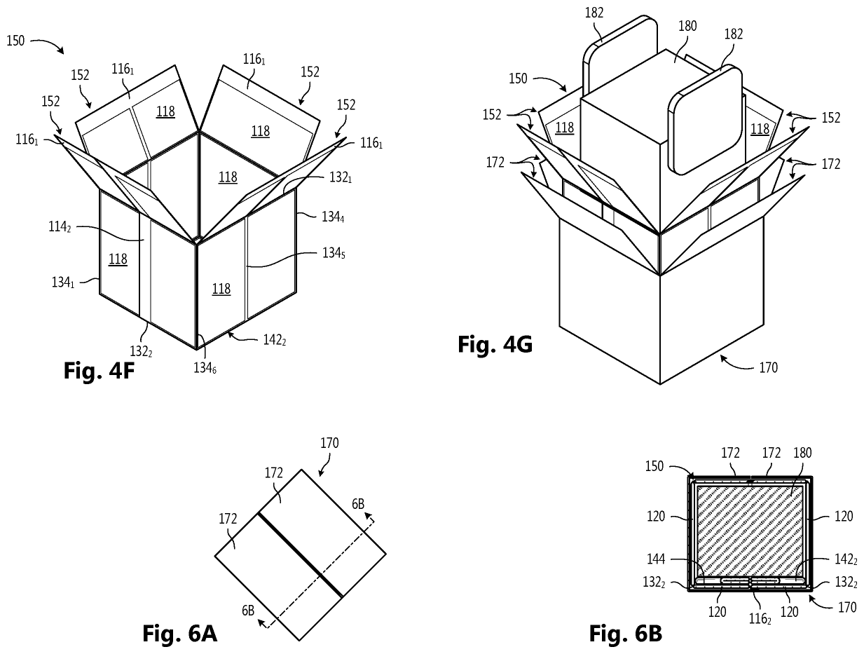

The insulation pad 100 can be formed into an insulation pouch 150. FIGS. 4A to 4G depict instances of an embodiment of a method of forming the insulation pad 100 into the insulation pouch 150 and using the insulation pouch 150 as thermal insulation for a shipping container. In the instance depicted in FIG. 4A, the insulation pad 100 has been formed into a tube shape. In the depicted embodiment, the insulation pad 100 has been formed into a tube shape by coupling the transverse edges 114 of the insulation pad 100 to each other. The transverse edges 114 of the insulation pad 100 can be coupled to each other can be accomplished by coupling the transverse edge 114₁ directly to the transverse edge 114₂, by coupling the transverse edge 114₁ directly to one or more of the insulation regions 118 adjacent to the transverse edge 114₂, and/or by coupling the transverse edge 114₂ directly to one or more of the insulation regions 118 adjacent to the transverse edge 114₁. In some embodiments, the transverse edges 114 of the insulation pad 100 can be coupled to each other using one or more of an adhesive, a fastener, a heat seal, tape, or any other coupling mechanism. In the depicted embodiment, the insulation pad 100 was folded about the transverse fold lines 134₁, 134₃, 134₄, and 134₆ to form the insulation pad 100 into a tube shape. The tube shape can have a rectangular cross-sectional shape (as shown in the depicted embodiment), a round cross-sectional shape, or any other cross-sectional shape.

From the instance depicted in FIG. 4A to the instance depicted in FIG. 4B, a W-shaped fold 140₁ and a W-shaped fold 140₂ (collectively, W-shaped folds 140) have been formed in the insulation pad 100. The W-shaped folds 140 have a profile that appears in the shape of the letter “W” when viewing either end of the insulation pad 100 in a direction parallel to the transverse fold lines 134. Each of the W-shaped folds 140 includes a “valley” fold and two “mountain” folds, with a mountain fold on either side of the valley fold. In the depicted embodiment, the transverse fold line 134₂ has been valley-folded and the transverse fold lines 134₁ and 134₃ have been mountain-folded on either side of the transverse fold line 134₂ to form the W-shaped fold 140₁. Similarly, the transverse fold line 134₅ has been valley-folded and the transverse fold lines 134₄ and 134₆ have been mountain-folded on either side of the transverse fold line 134₅ to form the W-shaped fold 140₂. In some embodiments, the W-shaped folds 140 extend from the longitudinal edge 116₁ to the longitudinal edge 116₂.

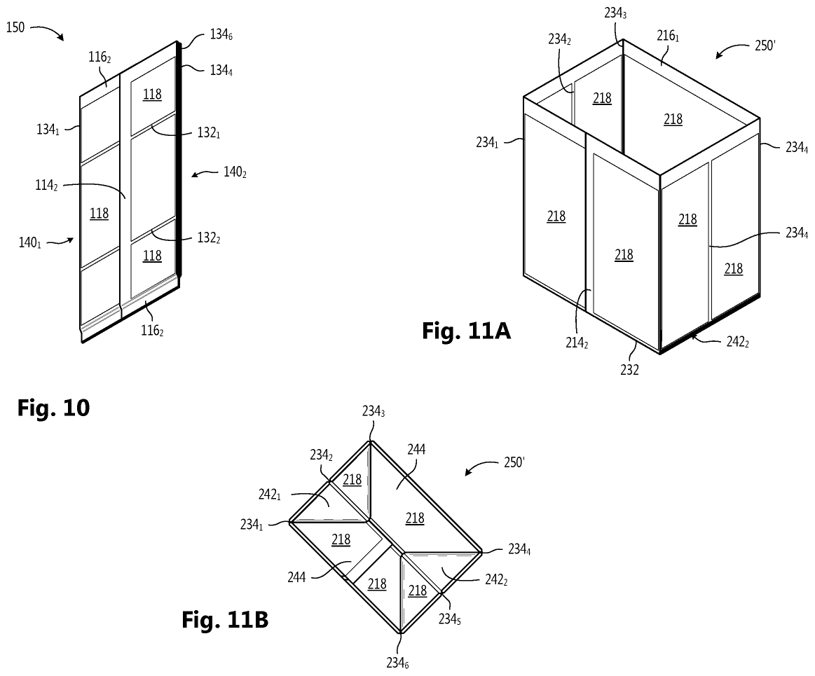

From the instance depicted in FIG. 4B to the instance depicted in FIG. 4C, portions of the longitudinal edge 116₂ have been coupled to each other between the two W-shaped folds 140 to close one end of the tube shape and form the insulation pouch 150 from the insulation pad 100. In the depicted embodiment, the longitudinal edge 116₂ was folded toward the side of the insulation pouch 150 where the transverse edges 114 are coupled to each other. The longitudinal edge 116₂ was also coupled to portions of the side of the insulation pouch 150 that includes the transverse edges 114. In some embodiments, the portions of the longitudinal edge 116₂ can be coupled to each other using one or more of an adhesive, a fastener, a heat seal, tape, or any other coupling mechanism. In some embodiments, the portions of the longitudinal edge 116₂ are coupled to each other between so that the coupled portions of the longitudinal edge 116₂ tend to hold the two W-shaped folds 140 in their folded shape. The portions of the longitudinal edge 116₂ can be coupled to each other ways. For example, FIG. 10 depicts a variation of the insulation pouch 150 where inner sides of the longitudinal edge 116₂ are coupled to each other and the longitudinal edge 116₂ is not directly coupled to the outer sides of the insulation regions 118. Other variations are also possible.

In depictions shown in FIG. 4C and FIG. 10, the insulation pouch 150 is in a lay-flat configuration. In the depicted embodiment, the longitudinal fold lines 132 are in an unfolded state and the transverse fold lines 134 are in a folded state. It will be apparent that the insulation pouch 150 is not completely flat when in the lay-flat configuration. For example, in the depicted embodiment, some areas of the insulation pouch 150, such as the W-shaped folds 140, have multiple layers of the thickness of the insulation regions 118. For example, even when the average thickness of the insulation regions 118 is less than 0.5 inches, the overall thickness of the W-shaped folds 140 when the insulation pouch 150 is in the flat configuration can be greater than 1 inch. The lay-flat configuration of the insulation pouch 150 can be convenient for storing the insulation pouch 150 or shipping a number of pouches together.

From the instance depicted in FIG. 4C to the instance depicted in FIG. 4D, the insulation pouch 150 has been reoriented from a horizontal position to a vertical position. From the lay-flat configuration shown in FIG. 4D, the insulation pouch 150 can be folded along the longitudinal fold line 132₁ to open to an open configuration shown in FIG. 4E. In some embodiments, the insulation pouch 150 can be folded along the longitudinal fold line 132₁ by placing the insulation pouch 150 in the vertical position with the longitudinal edge 116₂ located on a surface. For example, the longitudinal edge 116₂ can be located on a table top, a horizontal surface of a workstation, or the bottom of a shipping container (e.g., a cardboard box). A downward force can then be applied to the longitudinal edge 116₁ to create a compressive force in the insulation pouch 150 between the longitudinal edges 116. For example, a user can push downward on the longitudinal edge 116₁ while the longitudinal edge 116₂ is on a surface. The compressive force on the insulation pouch 150 can cause the pouch to fold along the longitudinal fold line 132₁ and open from the lay-flat configuration shown in FIG. 4D to the open configuration shown in FIG. 4E. When the insulation pouch 150 is in the open configuration, a user can place objects in the insulation pouch 150. For example, one or more of a product to be shipped, a cold pack, any other object can be placed in the insulation pouch 150. In the depicted embodiment, the W-shaped folds 140 have been unfolded and portions of the transverse fold lines 134₂ and 134₅ have been straightened.

FIGS. 5A and 5B depict top and cross-sectional views, respectively, of the insulation pouch 150 in the open configuration shown in FIG. 4E. In the open configuration, portions of the insulation pad 100 are in overlapping arrangements 142₁, 142₂ (collectively, overlapping arrangements 142). As can be seen in FIGS. 5A and 5B, the overlapping arrangements 142 are on the inner side of the bottom 144 of the insulation pouch 150. In the depicted embodiment, the overlapping arrangements 142 include folds through the insulation regions 118 of the insulation pad 100. The result of folding the insulation regions 118 is that more than one thickness of the insulation regions 118 is located above the bottom 144 of the insulation pouch 150. As can be seen in FIG. 5B, the tops of the overlapping arrangements 142 are above the inner side of the bottom 144 of the insulation pouch 150. Normally, given the thickness of the insulation regions 118, such a structure of the overlapping arrangements 142 would seem to be disadvantageous. However, this structure of the overlapping arrangements 142 can be very beneficial, as is discussed below.

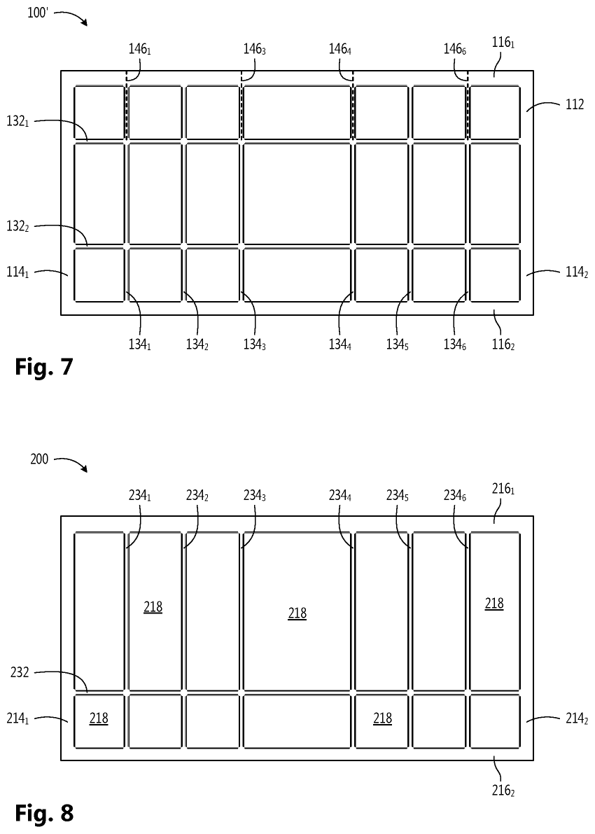

From the instance depicted in FIG. 4E to the instance depicted in FIG. 4F, portions of the insulation pad 100 between the longitudinal fold line 132₁ and the longitudinal edge 116₁ have been broken to form flaps 152. In the depicted embedment, the broken portions of the insulation pad 100 are located along the transverse fold lines 134₁, 134₃, 134₄, and 134₆ between the longitudinal fold line 132₁ and the longitudinal edge 116₁. In some embodiments, the portions of the insulation pad 100 between the longitudinal fold line 132₁ and the longitudinal edge 116₁ can been broken by cutting, tearing, or otherwise breaking the first and second sheets 110 and 112. In some embodiments, the insulation pad 100 includes lines of weakness in the portions that are intended to be broken to form the flaps 152. FIG. 7 depicts an embodiment of an insulation pad 100′ that is a variation of the insulation pad 100 that includes lines of weakness to allow a user to easily break the insulation pad 100′ to form flaps. In particular, the insulation pad 100′ includes lines of weakness 146₁, 146₃, 146₄, and 146₆ (collectively, lines of weakness 146) along the transverse fold lines 134₁, 134₃, 134₄, and 134₆ between the longitudinal fold line 132₁ and the longitudinal edge 116₁. The lines of weakness 146 are any weakened portions of the first and/or second sheets 110 and 112 that allow a user to easily break the insulation pad 100′, such as perforation lines, score line, crimp lines, and the like. In yet other embodiments, the insulation pad 100′ can have slits in place of the lines of weakness 146 so that the flaps 152 are already pre-cut before the insulation pad 100′ is opened to the open configuration.

Referring back to FIG. 4F, the flaps 152 are capable of being folded about the longitudinal fold line 132₁. In FIG. 4F, the flaps 152 have been folded outward. In this position, a user may be able to insert products, cold packs, heat packs, or other items into the insulation pouch 150. The flaps 152 may also be folded inward toward to close the insulation pouch 150 from the open configuration to a closed configuration. For example, in the closed configuration, the flaps 152 may overlap each other and cover the top of the insulation pouch 150. When the flaps 152 cover the top of the insulation pouch 150 and the insulation pouch 150 is in the closed configuration, the insulation pouch 150 provides thermal insulation around the interior of the insulation pouch 150 from the single insulation pad 100. In the positioning in the depicted embodiment, the only seams in the insulation pouch 150 are located at the top of the insulation pouch 150. This positioning causes any moisture in the insulation pouch 150 (e.g., moisture from condensation around cold packs) to remain within the insulation pouch 150. For example, any moisture in the insulation pouch 150 is capable of flowing to and pooling on the bottom 144 of the insulation pouch 150.

FIG. 4G shows the use of the insulation pouch 150 as a liner along inner sides of a shipping container 170. In some embodiments, the insulation pouch 150 can be placed in the shipping container 170 (e.g., a cardboard box) while in the open configuration, as shown in FIG. 4G. In other embodiments, the insulation pouch can be placed in the shipping container 170 in the lay-flat configuration and opened to the open configuration while in the shipping container 170. For example, the insulation pouch 150 can be placed into the shipping container 170 in the orientation shown in FIG. 4D and a user can apply a downward force to the insulation pouch 150 while the longitudinal edge 116₂ is on the bottom of the shipping container 170. This force can cause the insulation pouch 150 to open from the lay-flat configuration to the open configuration while in the shipping container 170.

With the insulation pouch 150 in the open configuration, a user can place a product 180 and a cold pack 182 inside the insulation pouch 150. In the embodiment shown in FIG. 4G, the product 180 is in the form of a single item. In other embodiments, the product 180 can be multiple items. The product 180 can be any item or combination of items, such as a food product, a pharmaceutical product, a biological sample, any other temperature-sensitive product, or any combination thereof. In the depicted embodiment, the cold pack 182 includes two items. In other embodiments, the cold pack 182 can include a single item or more than two items. The cold pack 182 can include an ice pack (e.g., a bag filled with solid water), a gel pack (e.g., a bag filled with refrigerant gel, a pack with any other type of liquid, an instant cold pack (e.g., a bag holding comments that, when mixed, undergo an endothermic reaction to remove heat from the area surrounding the bag), any other cold pack, or any combination thereof. In alternate embodiments, the cold pack 182 can be replaced by a heat pack, such as when the product 180 is to be kept at an elevated temperature.

After the product 180 and the cold pack 182 are placed in the insulation pouch 150, the insulation pouch 150 can be closed from the open configuration to the closed configuration. For example, the flaps 152 can be folded inward to close the insulation pouch 150 with the flaps 152 located over the product 180. The shipping container 170 also includes flaps 172 that can be folded down on top of the insulation pouch 150. For example, the flaps 172 that can be folded down on top of the flaps 152 of the insulation pouch 150. The flaps 172 can be held closed (e.g., taped, glued, stapled, etc.) to form a shippable package with the product 180 located inside and the insulation pouch 150 providing thermal insulation for the product 180.

FIGS. 6A and 6B depict top and cross-sectional views, respectively, of the package that includes the shipping container 170 with the flaps 172 closed, the insulation pouch 150 in the closed configuration, and the product 180 inside the insulation pouch 150. As can be seen in FIG. 6B, the product 180 rests on the tops of the overlapping arrangements 142 so that the product 180 does not contact the bottom 144 of the insulation pouch 150. Because the product 180 does not contact the bottom 144 of the insulation pouch 150, a gap exists between the product 180 and the bottom 144 of the insulation pouch 150. While this gap between the product 180 and the bottom 144 of the insulation pouch 150 may seem like a disadvantage, the gap can prevent the product 180 from contacting any moisture that has pooled on the bottom 144 of the insulation pouch 150. In this way, the gap can prevent the product 180 from being damaged (e.g., aesthetically damaged, functionally damaged, etc.) from contact with any moisture pooled on the bottom 144 of the insulation pouch 150.

In some embodiments, the overlapping arrangements 142 include multiple thicknesses of the insulation regions 118 to hold the product 180. Where the insulation regions 118 or the insulation pad 100 have an R-value per inch between about 3.70 and about 3.98 (an RSI-value per millimeter in a range between about 0.652 and about 0.701), the thickness of the insulation regions 118 can cause the gap between the bottom 144 of the insulation pouch 150 and the product 180 to be equal to or greater than one or more of 0.25 inches (0.64 cm), 0.375 inches (0.95 cm), 0.5 inches (1.27 cm), 0.625 inches (1.59 cm), or 0.75 inches (1.91 cm). Where the insulation regions 118 have a thickness equal to or greater than one or more of 0.2 inches (5.1 mm), 0.3 inches (7.6 mm), 0.4 inches (10.2 mm), or 0.5 inches (12.7 mm), the gap between the bottom 144 of the insulation pouch 150 and the product 180 to be equal to or greater than one or more of 0.25 inches (0.64 cm), 0.375 inches (0.95 cm), 0.5 inches (1.27 cm), 0.625 inches (1.59 cm), or 0.75 inches (1.91 cm).

In the depicted embodiment, the insulation pouch 150 is used as a thermally-insulating liner along inner sides of the shipping container 170. In other embodiments, insulation pouches similar to the insulation pouch 150 can be used as a thermally-insulating bag. In such a case, the insulation pouch can be formed with one or more longitudinal fold lines.

Depicted in FIG. 8 is a front view of an embodiment of an insulation pad 200 that can be formed into an insulation pouch. The insulation pad 200 includes two juxtaposed cellulose-based sheets that are laminated together with a cellulose-based insulation material located therebetween. In some embodiments, the cellulose-based sheets are paper, such as Kraft paper (e.g., 30# Kraft paper, 35# Kraft paper, 40# Kraft paper, 50# Kraft paper, etc.), coated paper, cotton paper, or any other type of paper. In some embodiments, the insulation material is a cellulose-based insulation material, such as natural fibers (cotton, wool, etc.), manufactured cellulose fibers (e.g., rayon, viscose), processed materials (e.g., pulp, paper, etc.), any other cellulose-based material, or any combination thereof. In some embodiments, the sheets and the insulation material are made from materials that are recyclable without separating the sheets from the insulation material. In some embodiments, one or both of the sheets and the insulation material includes post-consumer content. The insulation pad 200 can be formed in ways similar to those described above with respect to insulation pad 100 and FIGS. 1A to 3B.

The lamination of the cellulose-based sheet can cause the sheets to be bonded to each other in specific areas, such as areas where the insulation material is not located between the sheets. In the depicted embodiment, the sheets are bonded to each other along transverse edges 214₁, 214₂ (collectively, transverse edges 214) of the insulation pad 200, along longitudinal edges 216₁, 216₂ (collectively, longitudinal edges 216) of the insulation pad 200, along a longitudinal fold line 232 of the insulation pad 200, and along transverse fold lines 234₁, 234₂, 234₃, 234₄, 234₅, 234₆ (collectively, transverse fold lines 234) of the insulation pad 200. In some embodiments, the laminating of the sheets along the transverse and longitudinal edges 214 and 216 and along the longitudinal and transverse fold lines 232 and 234 forms insulation regions 218 where the insulation material is located between the sheets.

The longitudinal fold line 232 and the transverse fold lines 234 are more easily folded than other areas of the insulation pad 200, such as the insulation regions 218. While the longitudinal fold lines 232 and the transverse fold lines 234 may be easier to fold than the insulation regions 218, it will be appreciated that the insulation regions 218 can be folded. Examples of fold the insulation regions 218 are discussed below. In some embodiments, the longitudinal fold line 232 and the transverse fold lines 234 are more easily folded than the insulation regions 218 because there is less of the insulation material between the sheets in the longitudinal fold line 232 and the transverse fold lines 234 than in the insulation regions 218. In some embodiments, none of the insulation material is located between the sheets in portions of the longitudinal fold line 232 and the transverse fold lines 234. In some embodiments, the insulation material is located between the sheets in the longitudinal fold line 232 and the transverse fold lines 234, but the thickness of the insulation material in the longitudinal fold lines 232 and the transverse fold lines 234 is less than the average thickness of the insulation material in the insulation regions 218.

In some embodiments, the insulation pad 200 has thermal properties that allow the insulation pad 200 to be used in particular packaging situations. In some embodiments, the insulation pad 200 has an R-value per inch between about 3.70 and about 3.98 (an RSI-value per millimeter in a range between about 0.652 and about 0.701). In some embodiments, at least one of the insulation regions 218 of the insulation page 200 has an R-value per inch between about 3.70 and about 3.98 (an RSI-value per millimeter in a range between about 0.652 and about 0.701). In some embodiments, the insulation regions 218 have an average thickness equal to or greater than one or more of 0.2 inches (5.1 mm), 0.3 inches (7.6 mm), 0.4 inches (10.2 mm), or 0.5 inches (12.7 mm).

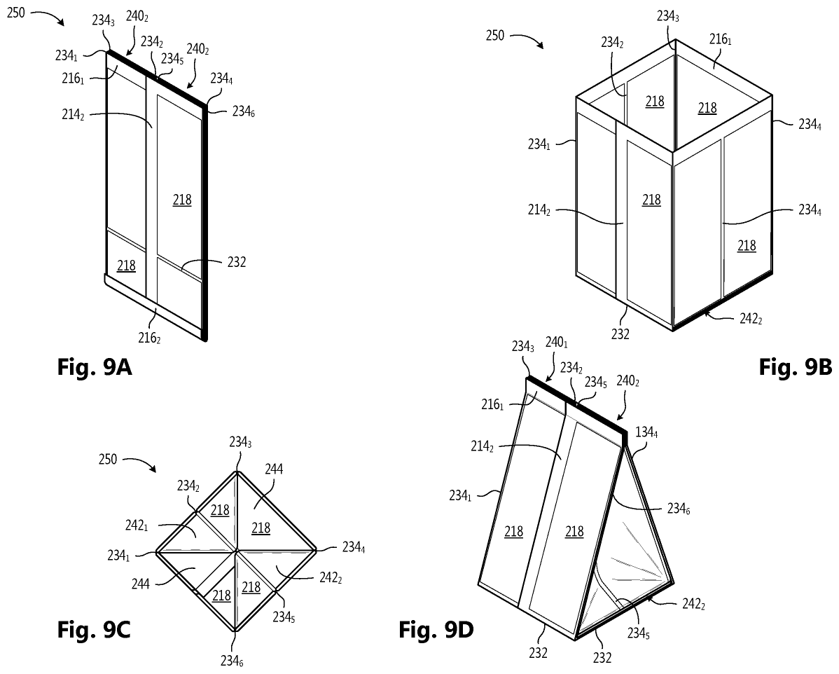

The insulation pad 200 can be formed into an insulation pouch 250. FIGS. 9A to 9D depict an embodiment of the transition of the insulation pouch 250 from a lay-flat configuration to an open configuration. To arrive at the lay-flat configuration shown in FIG. 9A, the insulation pad 200 can be formed into the insulation pouch 250 in ways similar to those described above with respect to the insulation pad 100 and FIGS. 4A to 4C. More specifically, in some embodiments, the insulation pad 200 can be formed into a tube shape. In some cases, the insulation pad 200 can been formed into a tube shape by coupling the transverse edges 214 of the insulation pad 200 to each other (e.g., using one or more of an adhesive, a fastener, a heat seal, tape, or any other coupling mechanism). After the insulation pad 200 is in a tube shape, a W-shaped fold 240₁ and a W-shaped fold 240₂ (collectively, W-shaped folds 240) can be formed in the insulation pad 200. For example, the transverse fold line 234₂ has been valley-folded and the transverse fold lines 234₁ and 234₃ have been mountain-folded on either side of the transverse fold line 234₂ to form the W-shaped fold 240₁. Similarly, the transverse fold line 234₅ has been valley-folded and the transverse fold lines 234₄ and 234₆ have been mountain-folded on either side of the transverse fold line 234₅ to form the W-shaped fold 240₂. In some embodiments, the W-shaped folds 240 extend from the longitudinal edge 216₁ to the longitudinal edge 216₂. Portions of the longitudinal edge 216₂ have been coupled to each other between the two W-shaped folds 240 to close one end of the tube shape and form the insulation pouch 250 from the insulation pad 200. In the depicted embodiment, the longitudinal edge 216₂ was folded toward the side of the insulation pouch 250 where the transverse edges 214 are coupled to each other. The longitudinal edge 216₂ was also coupled to portions of the side of the insulation pouch 250 that includes the transverse edges 214.

In depiction shown in FIG. 9A, the insulation pouch 250 is in a lay-flat configuration. In the depicted embodiment, the longitudinal fold line 232 is in an unfolded state and the transverse fold lines 234 are in a folded state. It will be apparent that the insulation pouch 250 is not completely flat when in the lay-flat configuration. The lay-flat configuration of the insulation pouch 250 can be convenient for storing the insulation pouch 250 or shipping a number of pouches together. In FIG. 9A, the insulation pouch 250 is in a vertical position. From the lay-flat configuration shown in FIG. 9A, the insulation pouch 250 can be folded along the longitudinal fold line 232 to open to an open configuration shown in FIG. 9B. In some embodiments, the insulation pouch 250 can be folded along the longitudinal fold line 232 by placing the insulation pouch 250 in the vertical position with the longitudinal edge 216₂ located on a surface (e.g., a table top, a horizontal surface of a workstation, or the bottom of a shipping container) and exerting a downward force on the insulation pouch 250. The compressive force on the insulation pouch 250 can cause the pouch to fold along the longitudinal fold line 232 and open from the lay-flat configuration to the open configuration shown in FIG. 9B. When the insulation pouch 250 is in the open configuration, a user can place objects in the insulation pouch 250. For example, one or more of a product to be shipped, a cold pack, any other object can be placed in the insulation pouch 250. In the depicted embodiment, the W-shaped folds 240 have been unfolded and portions of the transverse fold lines 234₂ and 234₅ have been straightened.

FIG. 9C depicts a top view of the insulation pouch 250 in the open configuration shown in FIG. 9B. In the open configuration, portions of the insulation pad 200 are in overlapping arrangements 242₁, 242₂ (collectively, overlapping arrangements 242). In some embodiments, the overlapping arrangements 242 are on the inner side of the bottom 244 of the insulation pouch 250. In the depicted embodiment, the overlapping arrangements 242 include folds through the insulation regions 218 of the insulation pad 200. The result of folding the insulation regions 218 is that more than one thickness of the insulation regions 218 is located above the bottom 244 of the insulation pouch 250. The tops of the overlapping arrangements 242 are above the inner side of the bottom 244 of the insulation pouch 250. Normally, given the thickness of the insulation regions 218, such a structure of the overlapping arrangements 242 would seem to be disadvantageous. However, this structure of the overlapping arrangements 242 can be very beneficial.

With the insulation pouch 250 in the open configuration, a user may be able to insert products, cold packs, heat packs, or other items into the insulation pouch 250. With the product placed inside of the insulation pouch 250, the insulation pouch 250 can serve as a thermal-insulating bag. When a product is placed in the insulation pouch 250, the product rests on the tops of the overlapping arrangements 242 so that the product does not contact the bottom 244 of the insulation pouch 250 and a gap exists between the product and the bottom 244 of the insulation pouch 250. While this gap between the product and the bottom 244 of the insulation pouch 250 may seem like a disadvantage, the gap can prevent the product from contacting any moisture that has pooled on the bottom 244 of the insulation pouch 250. In this way, the gap can prevent the product from being damaged (e.g., aesthetically damaged, functionally damaged, etc.) from contact with any moisture pooled on the bottom 244 of the insulation pouch 250.

In some embodiments, the overlapping arrangements 242 include multiple thicknesses of the insulation regions 218 to hold the product. Where the insulation regions 218 or the insulation pad 200 have an R-value per inch between about 3.70 and about 3.98 (an RSI-value per millimeter in a range between about 0.652 and about 0.701), the thickness of the insulation regions 218 can cause the gap between the bottom 244 of the insulation pouch 250 and the product to be equal to or greater than one or more of 0.25 inches (0.64 cm), 0.375 inches (0.95 cm), 0.5 inches (1.27 cm), 0.625 inches (1.59 cm), or 0.75 inches (1.91 cm). Where the insulation regions 218 have a thickness equal to or greater than one or more of 0.2 inches (5.1 mm), 0.3 inches (7.6 mm), 0.4 inches (10.2 mm), or 0.5 inches (12.7 mm), the gap between the bottom 244 of the insulation pouch 250 and the product to be equal to or greater than one or more of 0.25 inches (0.64 cm), 0.375 inches (0.95 cm), 0.5 inches (1.27 cm), 0.625 inches (1.59 cm), or 0.75 inches (1.91 cm).

From the open configuration shown in FIGS. 9B and 9C to the instance depicted in FIG. 9D, portions of the longitudinal edge 216₁ have been brought together to close the insulation pouch 250. In the depicted embodiment, the portions of the longitudinal edge 216₁ have merely been brought together. In other embodiments, the portions of the longitudinal edge 216₁ can be coupled to each other (e.g., stapled, taped, glued, etc.) to hold the insulation pouch 250 closed. When the insulation pouch 250 is in the closed configuration, the insulation pouch 250 provides thermal insulation around the interior of the insulation pouch 250 from the single insulation pad 200. In the positioning in the depicted embodiment, the only seams in the insulation pouch 250 are located at the top of the insulation pouch 250. This positioning causes any moisture in the insulation pouch 250 (e.g., moisture from condensation around cold packs) to remain within the insulation pouch 250. For example, any moisture in the insulation pouch 250 is capable of flowing to and pooling on the bottom 244 of the insulation pouch 250.

The use of the insulation pouch 250 as a bag can be advantageous in certain circumstances other than the use of the insulation pouch 250 as a thermally-insulating liner for a shipping container. For example, grocery delivery services may place either hot or cold grocery items in the insulation pouch 250 to insulate the grocery items during transportation to the delivery location. In another example, some stores (e.g., grocery stores, restaurants, etc.) have pick-up service where a customer can order products remotely from the store (e.g., via a smartphone app), the customer drives to the store, and a store employee brings the purchased items to the customer's car. In these cases, it may be advantageous to store set aside temperature-sensitive items in the insulation pouch 250 that is more like a bag than a shipping container liner. The use of the insulation pouch 250 as a bag can be advantageous in any number of other situations.

While specific embodiments of insulating pads and pouches discussed above have been depicted with certain dimensions, it will be understood that the dimensions of the insulating pads and pouches can be adjusted as need to meet specific circumstances. Depicted in FIGS. 11A and 11B are perspective and top views, respectively, of an embodiment of an insulation pouch 250′ in an open configuration, where the insulation pouch 250′ is a variation of the insulating pouch 250. In particular, the width of the insulation pouch 250′ (e.g., the length of the longer sides from the top left to the bottom right) is greater than the corresponding width of the insulation pouch 250. These dimensions may be more appropriate for a given situation. The depth of the insulating pouch (e.g., the length of the shorter sides from the bottom left to the top right) is approximately the same as the corresponding depth of the insulation pouch 250. In one example, when delivering catering meals, it may be advantageous for the insulation pouch to have a shape of the insulation pouch 250 that can hold catering pans with warm food in them. It will be apparent that insulation pouches can have any other shape appropriate for a given situation.

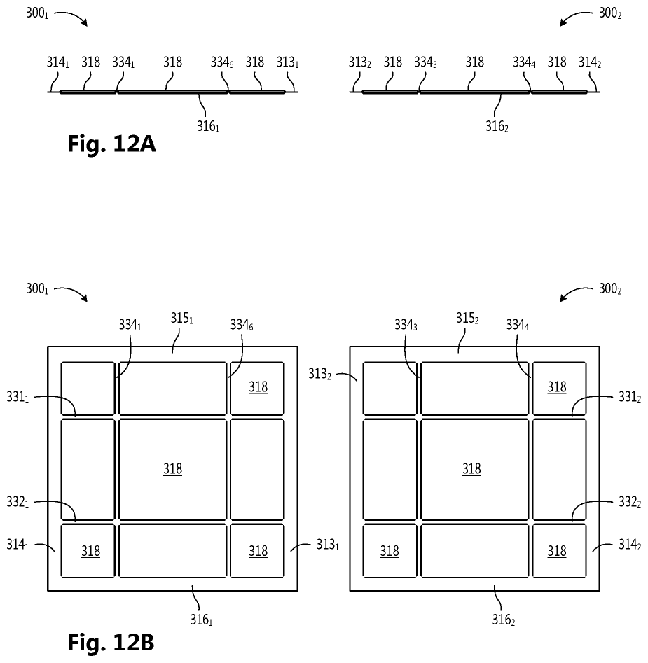

While the embodiments of insulation pads depicted and described above are in the form of a single-piece insulation pad, it will be apparent that any of the insulation pads described herein could be multi-piece insulation pads. Depicted in FIGS. 12A and 12B are side and front views, respectively, of insulation pad pieces 300₁ and 300₂ that can be combined to form an insulation pad that is usable in accordance with the other insulation pads described herein. Each of the insulation pad pieces 300₁ and 300₂ includes two juxtaposed cellulose-based sheets that are laminated together with a cellulose-based insulation material located therebetween. In some embodiments, the cellulose-based sheets are paper, such as Kraft paper (e.g., 30# Kraft paper, 35# Kraft paper, 40# Kraft paper, 50# Kraft paper, etc.), coated paper, cotton paper, or any other type of paper. In some embodiments, the insulation material is a cellulose-based insulation material, such as natural fibers (cotton, wool, etc.), manufactured cellulose fibers (e.g., rayon, viscose), processed materials (e.g., pulp, paper, etc.), any other cellulose-based material, or any combination thereof. In some embodiments, the sheets and the insulation material are made from materials that are recyclable without separating the sheets from the insulation material. In some embodiments, one or both of the sheets and the insulation material includes post-consumer content. The insulation pad pieces 300₁ and 300₂ can be formed in ways similar to those described above with respect to insulation pad 100 and FIGS. 1A to 3B.

The lamination of the cellulose-based sheet can cause the sheets to be bonded to each other in specific areas, such as areas where the insulation material is not located between the sheets. In the depicted embodiment of the insulation pad piece 300₁, the sheets are bonded to each other along transverse edges 313₁, 314₁ of the insulation pad piece 300₁, along longitudinal edges 315₁, 316₁ of the insulation pad piece 300₁, along longitudinal fold lines 331₁, 332₁ of the insulation pad piece 300₁, and along transverse fold lines 334₁, 334₆ of the insulation pad piece 300₁. In some embodiments, the laminating of the sheets along the transverse edges 313₁, 314₁, the longitudinal edges 315₁, 316₁, the longitudinal fold lines 331₁, 332₁, and the transverse fold lines 334₁, 334₆ forms insulation regions 318 where the insulation material is located between the sheets. In the depicted embodiment of the insulation pad piece 300₂, the sheets are bonded to each other along transverse edges 313₂, 314₂ of the insulation pad piece 300₂, along longitudinal edges 315₂, 316₂ of the insulation pad piece 300₂, along longitudinal fold lines 331₂, 332₂ of the insulation pad piece 300₂, and along transverse fold lines 334₃, 334₄ of the insulation pad piece 300₂. In some embodiments, the laminating of the sheets along the transverse edges 313₂, 314₂, the longitudinal edges 315₂, 316₂, the longitudinal fold lines 331₂, 332₂, and the transverse fold lines 334₃, 334₄ forms insulation regions 318 where the insulation material is located between the sheets.

The longitudinal fold lines 331₁, 331₂, 332₁, and 332₂ and the transverse fold lines 334₁, 334₃, 334₄, and 334₆ are more easily folded than other areas of the insulation pad pieces 300₁ and 300₂, such as the insulation regions 318. While the longitudinal fold lines 331₁, 331₂, 332₁, and 332₂ and the transverse fold lines 334₁, 334₃, 334₄, and 334₆ may be easier to fold than the insulation regions 318, it will be appreciated that the insulation regions 318 can be folded. In some embodiments, the longitudinal fold lines 331₁, 331₂, 332₁, and 332₂ and the transverse fold lines 334₁, 334₃, 334₄, and 334₆ are more easily folded than the insulation regions 318 because there is less of the insulation material between the sheets in the longitudinal fold lines 331₁, 331₂, 332₁, and 332₂ and the transverse fold lines 334₁, 334₃, 334₄, and 334₆ than in the insulation regions 318. In some embodiments, none of the insulation material is located between the sheets in portions of the longitudinal fold lines 331₁, 331₂, 332₁, and 332₂ and the transverse fold lines 334₁, 334₃, 334₄, and 334₆. In some embodiments, the insulation material is located between the sheets in the longitudinal fold lines 331₁, 331₂, 332₁, and 332₂ and the transverse fold lines 334₁, 334₃, 334₄, and 334₆, but the thickness of the insulation material in the longitudinal fold lines 331₁, 331₂, 332₁, and 332₂ and the transverse fold lines 334₁, 334₃, 334₄, and 334₆ is less than the average thickness of the insulation material in the insulation regions 318.

In some embodiments, the insulation pad pieces 300₁ and 300₂ have thermal properties that allow the insulation pad pieces 300₁ and 300₂ to be used in particular packaging situations. In some embodiments, each of the insulation pad pieces 300₁ and 300₂ has an R-value per inch between about 3.70 and about 3.98 (an RSI-value per millimeter in a range between about 0.652 and about 0.701). In some embodiments, at least one of the insulation regions 318 of one of the insulation pad pieces 300₁ and 300₂ has an R-value per inch between about 3.70 and about 3.98 (an RSI-value per millimeter in a range between about 0.652 and about 0.701). In some embodiments, the insulation regions 318 have an average thickness equal to or greater than one or more of 0.2 inches (5.1 mm), 0.3 inches (7.6 mm), 0.4 inches (10.2 mm), or 0.5 inches (12.7 mm).

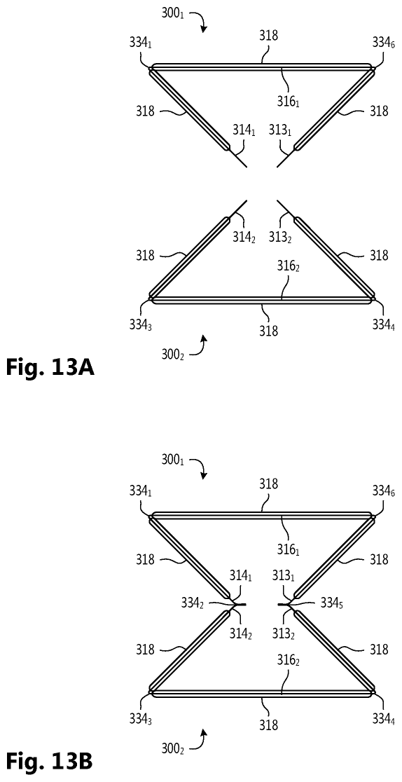

The insulation pad pieces 300₁ and 300₂ can be coupled together to form an insulation pad. Depicted in FIGS. 13A and 13B are side views of instances of a method of coupling the insulation pad pieces 300₁ and 300₂ to form an insulation pad with W-shaped folds. In FIG. 13A, the insulation pad piece 300₁ has been folded about the transverse fold lines 334₁, 334₆ and the insulation pad piece 300₂ has been folded about the transverse fold lines 334₃, 334₄. The insulation pad pieces 300₁ and 300₂ have been oriented with respect to each other such that the transverse edges 313₁, 314₁ of the insulation pad piece 300₁ are aligned with the transverse edges 313₂, 314₂, respectively, of the insulation pad piece 300₂. In FIG. 13B, the insulation pad pieces 300₁, 300₂ have been brought together so that the transverse edges 313₁ and 313₂ are in contact with each other and the transverse edges 314₁ and 314₂ are in contact with each other. At this point, the transverse edges 313₁ and 313₂ can be coupled (e.g., adhered, fastened, sealed, taped, or otherwise coupled) to each other and the transverse edges 314₁ and 314₂ can be coupled to each other.

When coupled to each other, the insulation pad pieces 300₁ and 300₂ form an insulation pad that can be formed into an insulation pouch. In the depicted embodiment, the transverse edges 313₁ and 313₂ form a transverse fold line 334₅ and the transverse edges 314₁ and 314₂ form a transverse fold line 334₂. The transverse fold lines 334₁, 334₂, and 334₃ form a W-shaped fold and the transverse fold lines 334₄, 334₅, and 334₆ form another W-shaped fold. From the instance shown in FIG. 13B, the insulation pad pieces 300₁ and 300₂ can be folded into a lay-flat configuration, such as the lay-flat configuration of the insulation pad 100 shown in FIG. 4B and portions of the longitudinal edges 316₁ and 316₂ can be coupled to each other to form an insulation pouch, similar to the way that the insulation pouch 150 has been formed from the insulation pad 100 in FIG. 4C. From that point, the insulation pouch formed from the insulation pad pieces 300₁ and 300₂ can be manipulated similar to the ways that the insulation pouch 150 is manipulated in FIGS. 4D to 4G.

It will be apparent to those skilled in the art that any number of insulation pad pieces can be coupled together to form an insulation pad. It will also be apparent that transverse edges of insulation pads or insulation pad pieces can be coupled together to form transverse folds (e.g., as shown in FIG. 13B) or can be coupled away from transverse folds (e.g., as shown in FIG. 4A). It will also be apparent that longitudinal edges of insulation pads or insulation pad pieces can be coupled together to form longitudinal folds.

For purposes of this disclosure, terminology such as “upper,” “lower,” “vertical,” “horizontal,” “inwardly,” “outwardly,” “inner,” “outer,” “front,” “rear,” and the like, should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Unless stated otherwise, the terms “substantially,” “approximately,” and the like are used to mean within 5% of a target value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1. A method comprising:
forming an insulation pad into a tube shape, wherein the insulation pad includes two juxtaposed cellulose-based sheets and a cellulose-based insulation material, wherein the two juxtaposed cellulose-based sheets are laminated together with the cellulose-based insulation material located therebetween, and wherein the insulation pad includes a plurality of transverse fold lines;
folding the insulation pad along the plurality of transverse fold lines to form two W-shaped folds in the insulation pad;
coupling portions of a first longitudinal edge of the insulation pad to each other between the two W-shaped folds in the insulation pad to close one end of the tube shape and form a pouch from the insulation pad; and
forming one of the plurality of transverse fold lines by directing a stream of compressed gas along a linear path in the cellulose-based insulation material before the two juxtaposed cellulose-based sheets are laminated together.

2. (canceled)

3. The method of claim 1, wherein the insulation pad further comprises a first longitudinal fold line.

4. The method of claim 3, further comprising:
folding the pouch along the first longitudinal fold line so that the pouch opens from a lay-flat configuration to an open configuration.

5. The method of claim 4, wherein, when the pouch is in the open configuration, portions of the insulation pad are in an overlapping arrangement on an inner side of a bottom of the pouch.

6. The method of claim 5, wherein the portions of the insulation pad in the overlapping arrangement include an insulation region of the insulation pad.

7.-8. (canceled)

9. The method of claim 5, further comprising:
placing a product in the pouch and on the portions of the insulation pad that are in the overlapping arrangement on the inner side of the bottom of the pouch.

10. The method of claim 9, further comprising:
closing the pouch from the open configuration to a closed configuration after placing the product in the pouch.

11. The method of claim 10, wherein the insulation pad includes lines of weakness between a second longitudinal fold line in the insulation pad and a second longitudinal edge, and wherein closing the pouch comprises:
breaking the lines of weakness to form flaps in between the second longitudinal fold line in the insulation pad and the second longitudinal edge of the insulation pad; and
folding the flaps about the second longitudinal fold line.

12. The method of claim 10, wherein:
the insulation pad includes slits between a second longitudinal fold line in the insulation pad and a second longitudinal edge;
the insulation pad further includes flaps bordered by the second longitudinal fold line in the insulation pad, the second longitudinal edge of the insulation pad, and at least two of the slits; and
closing the pouch comprises folding the flaps about the second longitudinal fold line.

13. The method of claim 4, further comprising:
inserting the pouch into a shipping container;
wherein, when the pouch is in the open configuration and inside of the shipping container, the pouch serves as a thermally-insulating liner along inner sides of the shipping container.

14. The method of claim 4, wherein folding the pouch along the first longitudinal fold line comprises:
exerting a compressive force between the first longitudinal edge and a second longitudinal edge of the insulation pad while the pouch is in the lay-flat configuration, wherein the compressive force causes the insulation pad to fold at the first longitudinal fold line to open the pouch to the open configuration.

15.-16. (canceled)

17. A pouch comprising:
an insulation pad comprising two juxtaposed cellulose-based sheets and a cellulose-based insulation material, wherein the two juxtaposed cellulose-based sheets are laminated together with the cellulose-based insulation material located therebetween;
a plurality of transverse fold lines in the insulation pad; and
two W-shaped folds in the insulation pad, wherein the two W-shaped folds are formed by folding the insulation pad along the plurality of transverse fold lines;
wherein portions of a first longitudinal edge of the insulation pad are coupled to each other between the two W-shaped folds in the insulation pad; and
wherein the insulation pad comprises:
lines of weakness between a second longitudinal fold line in the insulation pad and a second longitudinal edge of the insulation pad;
wherein, when the line of weakness are broken, the portions of the insulation pad between the second longitudinal fold line and the second longitudinal edge are flaps that can be folded about the second longitudinal fold line to close the pouch.

18. The pouch of claim 17, further comprising:
a first longitudinal fold line in the insulation pad.

19. The pouch of claim 18, wherein the pouch is configured to open from a lay-flat configuration to an open configuration when the insulation pad is folded about the first longitudinal fold line.

20. The pouch of claim 19, wherein, when the pouch is in the open configuration, portions of the insulation pad are in an overlapping arrangement on an inner side of a bottom of the pouch.

21. The pouch of claim 20, wherein the portions of the insulation pad in the overlapping arrangement include an insulation region of the insulation pad.

22. The pouch of claim 21, wherein the insulation region has an R-value per inch in a range between about 3.70 and about 3.98 (an RSI-value per millimeter in a range between about 0.652 and about 0.701).

23. The pouch of claim 21, wherein the insulation region has an average thickness equal to or greater than 0.2 inches (5.1 mm).

24. The pouch of claim 23, wherein the insulation region in the overlapping arrangement is folded such that at least two thicknesses of the insulating region are above the inner side of the bottom of the pouch.

25. The pouch of claim 17, wherein the insulation pad comprises: lines of weakness between a second longitudinal fold line in the insulation pad and a second longitudinal edge of the insulation pad;

26. The pouch of claim 17, wherein a first transverse side of the insulation pad is coupled to a second transverse side of the insulation pad.

27. The pouch of claim 17, wherein the insulation pad comprises a plurality of insulation pad pieces that are coupled to each other.

28. A package comprising:
a pouch comprising:
an insulation pad comprising two juxtaposed cellulose-based sheets and a cellulose-based insulation material, wherein the two juxtaposed cellulose-based sheets are laminated together with the cellulose-based insulation material located therebetween,
a plurality of transverse fold lines in the insulation pad,
two W-shaped folds in the insulation pad, wherein the two W-shaped folds are formed by folding the insulation pad along the plurality of transverse fold lines, and
a first longitudinal fold line in the insulation pad,
wherein portions of a first longitudinal edge of the insulation pad are coupled to each other between the two W-shaped folds in the insulation pad, and
wherein the pouch is configured to open from a lay-flat configuration to an open configuration when the insulation pad is folded about the first longitudinal fold line;
a product in the pouch; and
a cold pack in the pouch;
wherein the product is placed on the portions of the insulation pad that are in the overlapping arrangement on the inner side of the bottom of the pouch; and
wherein the product contacts the portions of the insulation pad that are in the overlapping arrangement and the product is not in contact with the bottom of the pouch.

29.-30. (canceled)

31. The package of claim 30, wherein the cold pack is placed in the pouch such that condensation from the cold pack is capable of flowing to and pooling on the bottom of the pouch so that the product is not in contact with pooled condensation on the bottom of the pouch.

32. The package of claim 28, further comprising:
a shipping container, wherein the pouch is positioned as a liner along inner sides of the shipping container.
